(19) United States
(12) Patent Application Publication
(10) Pub. No.: US 2013/0177098 A1
(43) Pub. Date: Jul. 11, 2013

(54) METHOD AND DEVICE FOR SELECTING ANTENNA IN MULTI- ANTENNA SYSTEM

(71) Applicants: Hoi Yoon Jung, Daejeon-si (KR); Jung Sun Um, Daejeon-si (KR); Sung Hyun Hwang, Daejeon-si (KR); Byung Jang Jeong, Daejeon-si (KR); Chang Joo Kim, Daejeon-si (KR); Jung Suk Joo, Seoul (KR)

(72) Inventors: Hoi Yoon Jung, Daejeon-si (KR); Jung Sun Um, Daejeon-si (KR); Sung Hyun Hwang, Daejeon-si (KR); Byung Jang Jeong, Daejeon-si (KR); Chang Joo Kim, Daejeon-si (KR); Jung Suk Joo, Seoul (KR)

(73) Assignees: HANKUK UNIVERSITY OF FOREIGN STUDIES RESEARCH AND INDUSTRY-UNIVERSITY COOPERATION FOUNDATION, Gyeonggi-do (KR); ELECTRONICS AND TELECOMMUNICATIONS RESEARCH INSTITUTE, Daejeon-si (KR)

(21) Appl. No.: 13/823,959

(22) PCT Filed: Sep. 23, 2011
(86) PCT No.: PCT/KR2011/007012

§ 371 Date: Mar. 15, 2013

(30) Foreign Application Priority Data
Sep. 28, 2010 (KR) 10-2010-0093789
Mar. 31, 2011 (KR) 10-2011-0029164

(51) Int. Cl. H04B 7/04

(52) U.S. Cl. CPC H04B 7/0456
USPC 375/267

(57) ABSTRACT

Provided is a method for selecting an antenna performed by a receiver in a multi-antenna system. The method for selecting the antenna performed by the receiver in the multi-antenna system, comprises: a subcarrier group setting step for setting subcarrier groups by grouping subcarriers; a channel information acquisition step for acquiring channel information between a receiving end antenna and each of a plurality of transmission end antennas; an antenna selecting step for determining said subcarrier groups, which are to be transmitted to each of the plurality of said transmission end antennas on the basis of said channel information; and an antenna selection information transmission step for transmitting antenna selection information, which contains the result of said antenna selection, to a transmission end.

### TECHNICAL FIELD

The present invention relates to wireless communication, and more particularly, to a method and an apparatus for selecting an antenna in a multi-antenna system.

### BACKGROUND ART

The demand for a communication service such as generation of an information communication service, appearance of various multimedia services, appearance of a high quality service, or the like, has rapidly increased. In order to satisfy this demand, research into various wireless communication technologies in several fields has been conducted.

The next generation wireless communication system should be capable of transmitting high quality and high capacity multimedia data at a high speed using a limited frequency resource. In order to enable the high quality and high capacity multimedia data to be transmitted at a high speed in a wireless channel having a limited bandwidth, inter-symbol interference and frequency selective facing that are generated at the time of high speed transmission should be overcome while frequency efficiency is maximized. In order to maximize the frequency efficiency, a multiple-input multiple-output (MIMO) technology using a multi-antenna has been used in various communication systems.

The MIMO technology may be mainly used for two purposes. First, the MIMO technology may be used for the purpose of increasing a diversity gain in order to reduce performance degradation due to a fading environment of a channel. Second, the MIMO technology may be used for the purpose of increasing a data rate in the same frequency band. The MIMO technology has an advantage in that it may transmit more data without increasing a frequency bandwidth, as compared to a single-input single-output (SISO) system using a single transceiving antenna.

In order to increase a diversity gain in a wireless communication system using a multi-antenna, a scheme of selecting an antenna for each of subcarriers and transmitting data using the selected antenna may be used. To this end, a receiving end transmits channel information of each subcarrier to a transmitting end, and the transmitting end selects an antenna based on channel information of each subcarrier and transmits data using the selected antenna. Therefore, a method for selecting an antenna and transmitting data for reducing feedback information (channel information of each subcarrier) which the transmitting end receives from the receiving end in order to select the antenna needs to be considered.

### DISCLOSURE

### Technical Problem

The present invention provides a method for obtaining channel information for selecting a transmitting antenna having good channel quality in a wireless communication system using a multi-antenna and transmitting data using the selected antenna, and a method for selecting an antenna and a method for transmitting data based on the channel information.

### Technical Solution

In an aspect, there is provided a method for selecting an antenna performed by a receiving end in a multi-antenna system, the method including: a subcarrier group setting step setting subcarrier groups by grouping subcarriers; a channel information obtaining step obtaining channel information between a receiving end antenna and each of a plurality of transmitting end antennas; an antenna selecting step determining the subcarrier groups to be transmitted to each of the plurality of transmitting end antennas based on the channel information; and an antenna selection information transmitting step transmitting antenna selection information including a result of the antenna selection to a transmitting end.

The subcarrier group setting step may include setting subcarriers subjected to a similar channel environment as one group.

The antenna selecting step may include determining the antenna selection information by comparing the channel information and a representative value of channel characteristics of the subcarrier group with each other.

The representative value of the channel characteristics of the subcarrier group may be obtained based on at least one of the sum, the average, the maximum value, and the minimum value of channel characteristics of each of subcarriers configuring the subcarrier group.

The antenna selection information may be an index of the transmitting end antennas corresponding to the subcarrier group.

In another aspect, there is provided a method for selecting an antenna performed by a transmitting end in a multi-antenna system, the method including: an antenna selection information receiving step receiving antenna selection information from a receiving end; and a subcarrier allocating step allocating subcarriers to each of a plurality of transmitting end antennas based on the antenna selection information, wherein the antenna selection information is determined based on channel information between a receiving end antenna and each of the plurality of transmitting end antennas.

The subcarrier allocating step may include allocating the subcarriers to each of the plurality of transmitting end antennas in a group unit by setting each of subcarriers subjected to a similar channel environment as one subcarrier group.

The antenna selection information may be determined by comparing the channel information and a representative value of channel characteristics of the subcarrier group with each other.

The representative value of the channel characteristics of the subcarrier group may be obtained based on at least one of the sum, the average, the maximum value, and the minimum value of channel characteristics of each of subcarriers configuring the subcarrier group.

The antenna selection information may be an index of the transmitting end antennas corresponding to the subcarrier group.

### Advantageous Effects

The data are transmitted under only a good channel environment selected among multiple channel environments for each subcarrier group in the multi-antenna system, thereby making it possible to improve the entire communication system performance. In addition, the feedback information transmitted from the receiving end to the transmitting end in order to allow the transmitting end to select a channel environment is reduced, thereby making it possible to improve utilization efficiency of a wireless resource.

### DESCRIPTION OF DRAWINGS

FIG. 1 shows an example of a structure of a multi-antenna multi-subcarrier wireless communication system.

FIG. 2 shows an example of a scheme of selecting an antenna for each subcarrier using feedback information in a multi-antenna system and transmitting data using the selected antenna.

FIG. 3 shows an example of a scheme of transmitting data using difference antennas with respect to each of odd numbered and even numbered subcarriers in a multi-antenna system.

FIG. 4 shows an example of a method for selecting an antenna and transmitting data using the selected antenna according to an embodiment of the present invention.

FIG. 5 is a block diagram showing a method for selecting an antenna and transmitting data using the selected antenna according to an embodiment of the present invention.

FIG. 6 shows an example of a method for transmitting data according to an embodiment of the present invention.

FIG. 7 is a block diagram of a wireless apparatus implementing an embodiment of the present invention.

### MODE FOR INVENTION

The present invention relates to a multi-antenna transmission method in which antennas are selected for each subcarrier group using channel information of each antenna in a multi-antenna system and data are transmitted using the selected antenna to obtain a transmission diversity gain. According to the related art, as a scheme of selecting an antenna, a scheme of transmitting channel information of each subcarrier from a receiving end to a transmitting end and selecting an antenna for each of subcarriers and transmitting data using the selected antenna at the transmitting end has been used. However, according to the present invention, a scheme of grouping subcarriers, selecting, at a receiving end, a transmitting antenna for each subcarrier group using channel information of each subcarrier group and transferring the selected information to a transmitting end, and transmitting, at the transmitting end, data according to the transferred information is used.

In the case of using the method suggested in the present invention, only an antenna index for each subcarrier group is transferred, thereby making it possible to reduce feedback information, and data are transmitted under only a good channel environment selected among multiple channel environments for each subcarrier due to a multi-antenna, thereby making it possible to improve the entire system performance. Hereinafter, the present invention will be described in more detail with the accompanying drawings. In the following description, as an example of a multi-antenna system, a transmitting end transmits data using two antennas, that is, an antenna 0 and an antenna 1. This multi-antenna system including two antennas is exemplified for convenience of explanation. Therefore, the scope and spirit of the present invention is not limited to the number of antennas of a transmitting end and a receiving end exemplified in the accompanying drawings. In addition, the scope and sprit of the present invention is not limited to the number of antennas and the number of subcarriers exemplified in the accompanying drawings and may be similarly applied to a system using a plurality of antennas and a plurality of subcarriers.

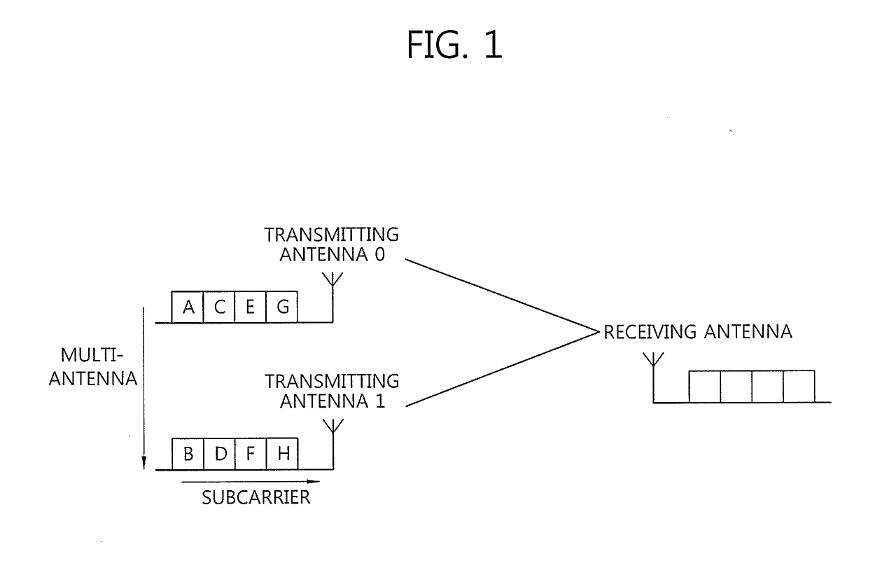

FIG. 1 shows an example of a structure of a multi-antenna multi-subcarrier wireless communication system.

A multi-antenna system, which is a communication system utilized to improve performance of a communication system by using a plurality of antennas at a transmitting end and a receiving end, has been introduced as a standard technology in most of the recent communication system standards. In addition, a multi-subcarrier scheme, which is a scheme of dividing a frequency band used by a system into multiple subcarriers and performing transmission, is a technology capable of efficiently overcoming channel characteristics of a multi-path channel. This multi-subcarrier scheme has also been reflected in most of the recent communication system standards.

In this multi-antenna multi-subcarrier system, different channel characteristics are shown between each of antennas and each of subcarriers due to spatial spacing caused by a spatial distance between the antennas and frequency spacing caused by frequency selective characteristics of channels. Therefore, when different channel characteristics between each of antennas and each of subcarriers are efficiently utilized, performance of the system may be improved.

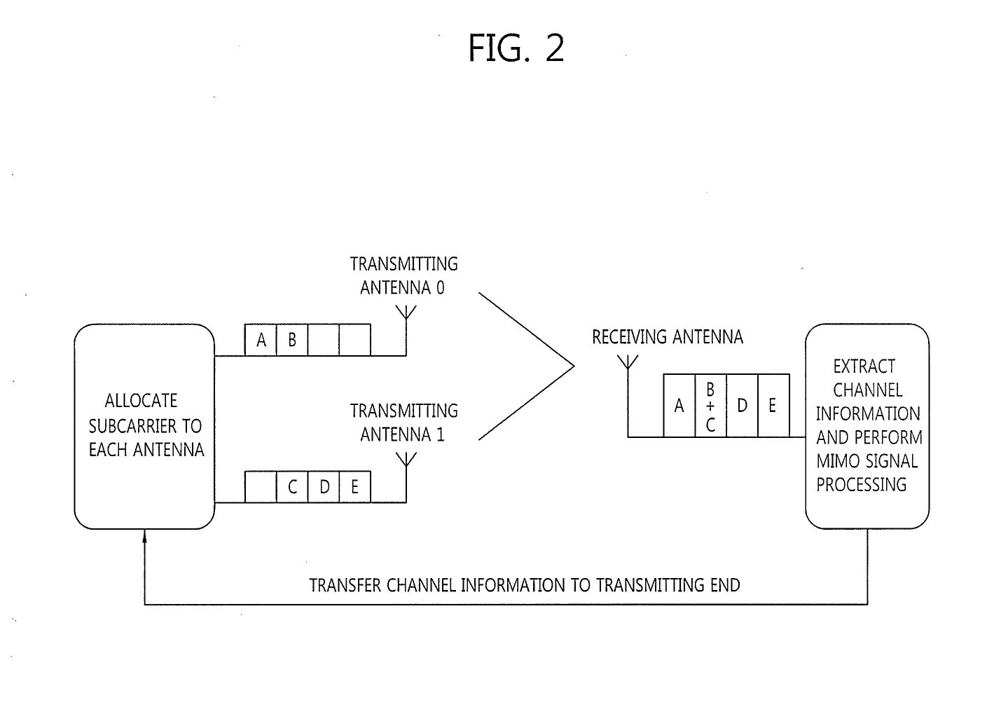

FIG. 2 shows an example of a scheme of selecting an antenna for each subcarrier using feedback information in a multi-antenna system and transmitting data using the selected antenna.

A receiving end extracts channel information for each subcarrier and transmits the extracted channel information to a transmitting end. The transmitting end allocates data to the subcarriers of each antenna based on the channel information received from the receiving end. Here, a channel state is evaluated based on any absolute value, such that data may be transmitted from all of the antennas on one subcarrier, and data may not be transmitted from any antenna on another subcarrier. The data transmitted as described above are received at the receiving end. According to this scheme, data transmitted from several antennas are received at the receiving end in a state in which they are combined with each other. Therefore, MIMO signal processing needs to be performed in order to detect each data.

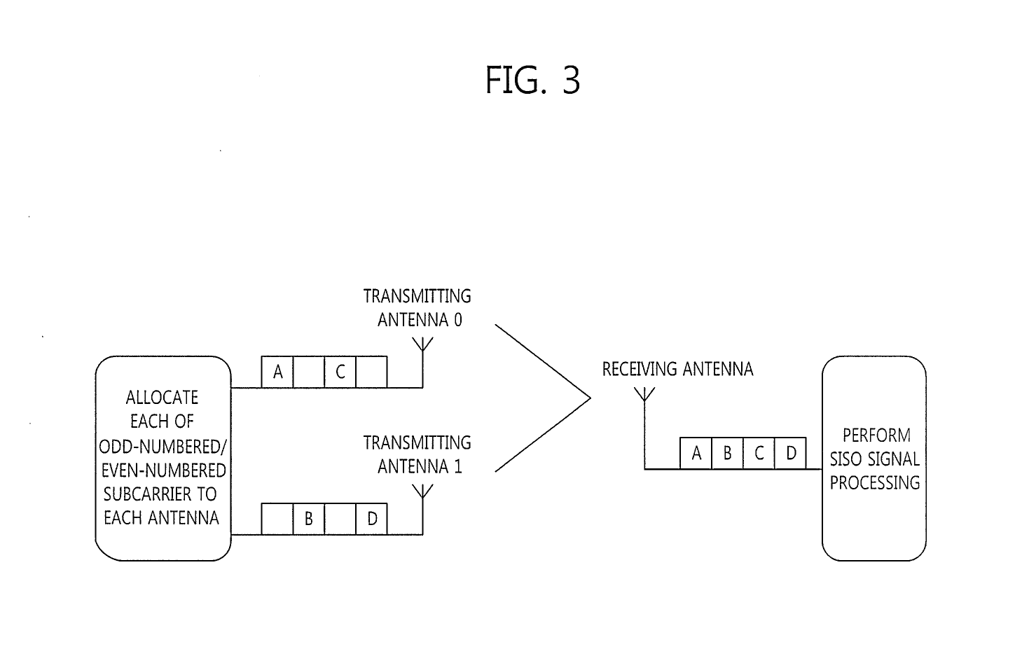

FIG. 3 shows an example of a scheme of transmitting data using difference antennas with respect to each of odd numbered and even numbered subcarriers in a multi-antenna system.

A scheme of transmitting data using a transmitting antenna 0 with respect to odd numbered subcarriers and transmitting data using a transmitting antenna 1 with respect to even numbered subcarriers may be used. The data are transmitted using the different antennas for each of the subcarriers as described above, such that they are received after being subjected to different channel environments, thereby making it possible to obtain a diversity gain. In addition, at the receiving end, data are not overlapped with each other for each of the subcarriers as if they are transmitted from a single antenna. Therefore, it is possible to detect a signal through the same reception signal processing as the reception signal processing in a single antenna system.

According to the embodiment of the present invention, each of the subcarriers is grouped, one of a plurality of transmitting antennas is selected using channel information of a corresponding group, and data is transmitted using the selected antenna. This transmission scheme may make a structure of reception signal processing simple as in the system of FIG. 3 and utilizes less feedback information than feedback information used in a scheme of FIG. 2, thereby making it possible to contribute to improving system performance.

The present invention suggests a scheme of selecting an antenna having a good channel state only using a small amount of feedback and transmitting data using the selected antenna, that is, a method in which only a single data is received on a single subcarrier at a receiving end, such that a signal may be detected by performing only existing SISO signal processing without performing complex MIMO signal processing and system performance may be improved.

Referring back to FIG. 1, in the system as shown in FIG. 1 in which two antenna are present in the transmitting end, a single antenna is present in the receiving end, and four subcarriers are present, there are two paths, that is, a path from the transmitting antenna 0 toward the receiving antenna and a path from the transmitting antenna 1 toward the receiving antenna. Generally, channel states of two paths are different. For example, even though a subcarrier A of the transmitting antenna 0 and a subcarrier B of the transmitting antenna 1 are subcarriers at the same frequency position, they may have different channel environments. In addition, when the channels have frequency selective characteristics, difference subcarriers within the same antenna may have different channel environments. For example, even in the same transmitting antenna 0, subcarriers A, C, E and G may have different channel environments.

Meanwhile, when the frequency selective characteristics are severe, channel environments may be independently changed for each subcarrier, and when the frequency selective characteristics are not severe, subcarriers adjacent to each other may have a similar channel environment.

In consideration of this feature, according to the embodiment of the present invention, the multi-antenna system suggested in the present invention groups subcarriers subjected to a similar channel environment, thereby making it possible to process them as one group. For example, when 98 subcarriers are present, they may be divided into 49 groups by grouping two subcarriers each, be divided into 14 groups by grouping seven subcarriers each, or be divided into two groups by grouping 49 subcarriers each. The number of subcarriers per one group and what subcarrier is allocated to each group may be changed according to the implementation of the system.

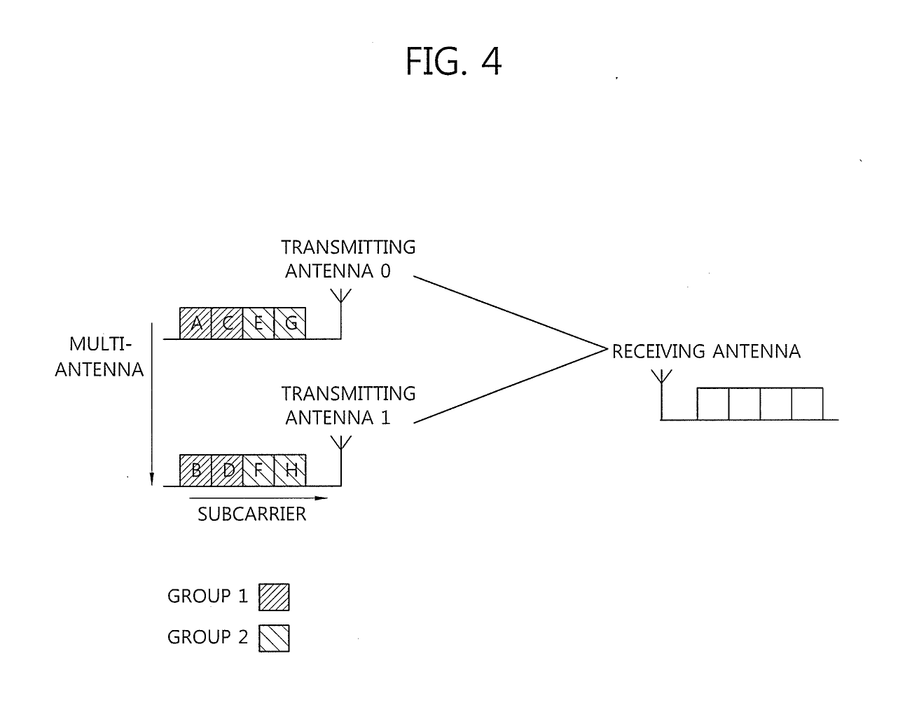

FIG. 4 shows an example of a method for selecting an antenna and transmitting data using the selected antenna according to an embodiment of the present invention.

An example of FIG. 4 is an example in which two subcarriers each are divide into two groups in the system of FIG. 1. After the subcarriers are grouped as described above, each subcarrier group shows different channel characteristics with respect to each transmitting antenna. Here, a representative value of channel characteristics of each subcarrier group may be the sum, the average, the maximum value, the minimum value. or the like, of channel to noise ratios (CNRs) of subcarriers within each subcarrier group according to the implementation. Further, a plurality of other variables may be used, in addition to the CNR value.

According to the representative value of the channel characteristics of the subcarrier group defined according to the system, the receiving end compares the representative values of the channel characteristics from each antenna with respect to each subcarrier group with each other, thereby making it possible to select the optimal transmitting antenna. For example, in the case of FIG. 4, with respect to the transmitting antenna 0, subcarriers A and C may be one group, and a representative value of channel characteristics of the group may be the sum, the average, the maximum value, the minimum value, or the like, of channel characteristic values of A and C. With respect to the transmitting antenna 1, subcarriers B and D correspond to the above-mentioned description.

As described above, the representative values of the channel characteristics of each subcarrier group are calculated with respect to each transmitting antenna and the transmitting antennas are then selected for each subcarrier grouping the receiving end.

Describing FIG. 4 by way of example, a channel characteristic value in the case in which the transmitting antenna 0 transmits data (in other words, in the case in which subcarriers A and C are used) and a channel characteristic value in the case in which the transmitting antenna 1 transmits data (in other words, in the case in which subcarriers B and D are used), with respect to a subcarrier group 1, are compared to each other.

It is determined which of the transmission of the data from the transmitting antenna 0 and the transmission of the data from the transmitting antenna 1 helps to improve the system performance through this comparison process. As an example, when the representative value of the channel characteristics is a CNR value, selecting a transmitting antenna having a large CNR value may help to improve the system performance. This performance determination reference may be changed according to the implementation of the system.

The receiving end determines what transmitting antenna should be used in order to optimally transmit the data with respect to each subcarrier group through above-mentioned process and transmits the determined antenna index to the transmitting end. The transmitting end determines what antenna is used to transmit the data with respect to each subcarrier group according to the transmitting antenna index received from the receiving end, allocates the antenna, and transmits the data.

Meanwhile, since the data is received only through a single antenna with respect to each subcarrier group at the receiving end, the data is received as if it is transmitted from a single antenna at the transmitting end. Therefore, the receiving end may detect the signal through the same signal processing process as that of a single antenna system without requiring a separate MIMO signal processing process.

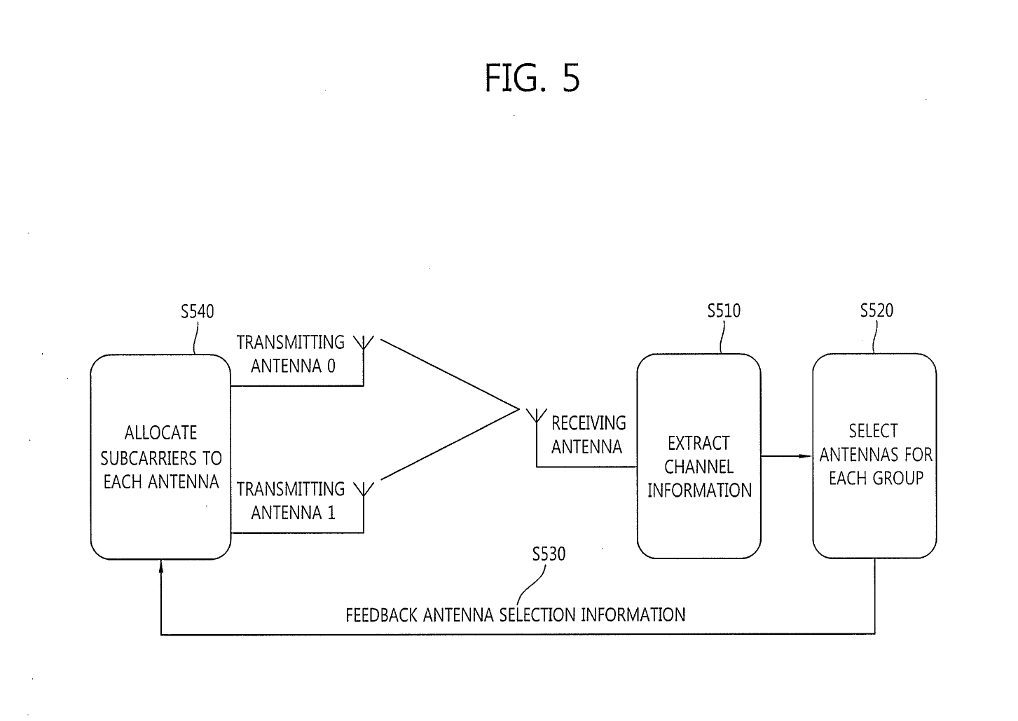

FIG. 5 is a block diagram showing a method for selecting an antenna and transmitting data using the selected antenna according to an embodiment of the present invention.

The method for selecting an antenna and transmitting data using the selected antenna according to an embodiment of the present invention includes extracting channel information at a receiving end (S510), and setting an antenna for each subcarrier group (S520). Antenna selection information, which is a result of operation (S520), is feedback to the transmitting end (S530). The transmitting end allocates subcarriers to each transmitting antenna thereof based on the feedback antenna selection information (S540). Here, an allocation unit of the subcarriers may be a subcarrier group. As described above, subcarriers subjected to a similar channel environment may be set as one group.

Then, the transmitting end may transmit data to a receiving end through subcarriers allocated to each transmitting antenna.

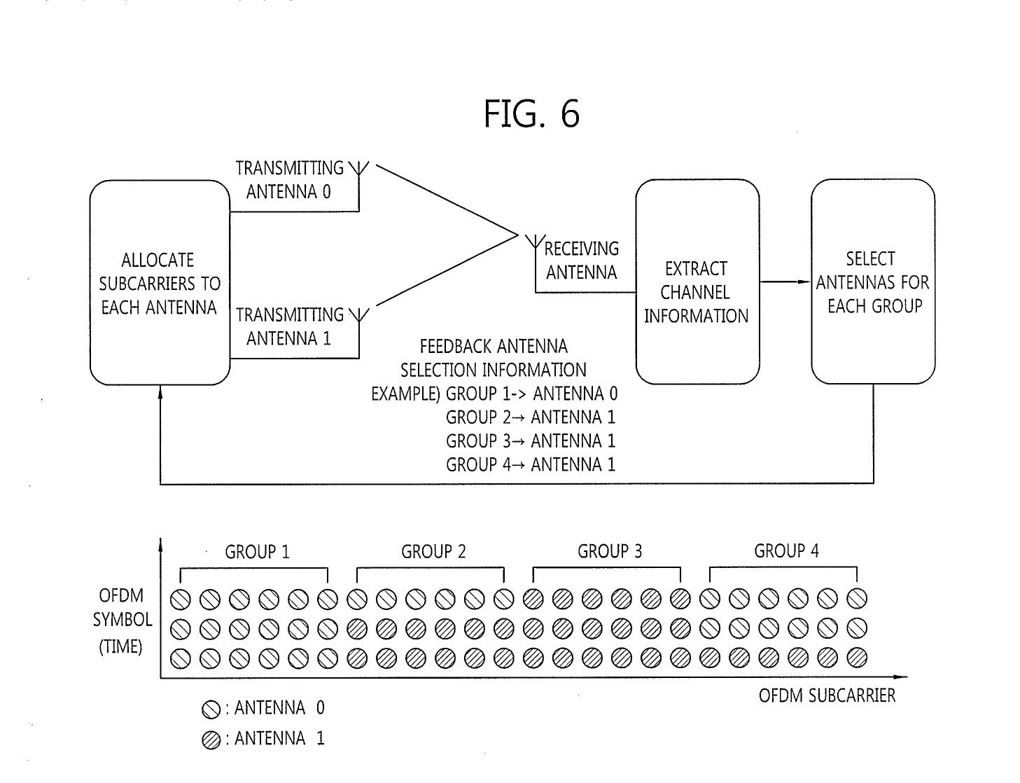

FIG. 6 shows an example of a method for transmitting data according to an embodiment of the present invention.

The example of FIG. 6 has assumed a communication system including two transmitting antenna, a single receiving antenna, and a total of twenty four subcarriers. Twenty four subcarriers are grouped into a total of four subcarrier groups by grouping six subcarriers each into one group. As a result of extracting channel information at the receiving end, it is determined that it is advantageous to transmit data from an antenna 0 with respect to a subcarrier group 1 and transmit data from an antenna 1 with respect to subcarrier groups 2 to 4. Therefore, the receiving end transfers 4 bits information of an antenna index 0, 1, 1, 1 for each group to the transmitting end. The transmitting end allocates transmitting antennas with respect to each subcarrier group according to this feedback information and transmits data. The receiving end receives all of data of the subcarrier groups 1 to 4 by receiving the data of the subcarrier group 1 from the transmitting antenna 0 and receiving the data of the subcarrier groups 2 to 4 from the transmitting antenna 1 and detects data by performing signal processing on the received data. Meanwhile, channel characteristics of each antenna and subcarrier may be changed according to time-variable characteristics of channels, apart from the frequency selective characteristics of the channels. The receiving end periodically checks the time-variable characteristics of the channels to again detect channel characteristics in each period, thereby making it possible to allow the data to be always transmitted from an optical antenna for each subcarrier group.

Although the above description has been provided on the assumption that the system includes two transmitting antenna and a single receiving antenna, the present invention is not limited to the above-mentioned system but may be applied to all multi-antenna systems including at least two transmitting antenna and at least one receiving antenna. Further, in a grouping method, each group may have any number of subcarriers and be defined as any subcarrier index, and channel characteristic indices of each group, which has any value, may be changed according to the implementation. In addition, selection criteria of antennas for each subcarrier group may be changed according to the purpose of the system.

As described above, in applying the present invention, the data are transmitted from the optimal transmitting antennas for each subcarrier group, thereby making it possible to improve the system performance. Further, only a subcarrier group index is transferred from the receiving end to the transmitting end to reduce the amount of feedback information, thereby making it possible to improve quality of service (QoS) of the system. Furthermore, only a single transmitting antenna is selected with respect to each subcarrier group and the data is transmitted using the selected antenna, thereby making it possible to obtain the same effect as the effect that a signal is received at a single antenna transmitting end in light of the receiving end. Therefore, a structure of a receiver is simplified, thereby making it possible to implement a efficient multi-antenna system.

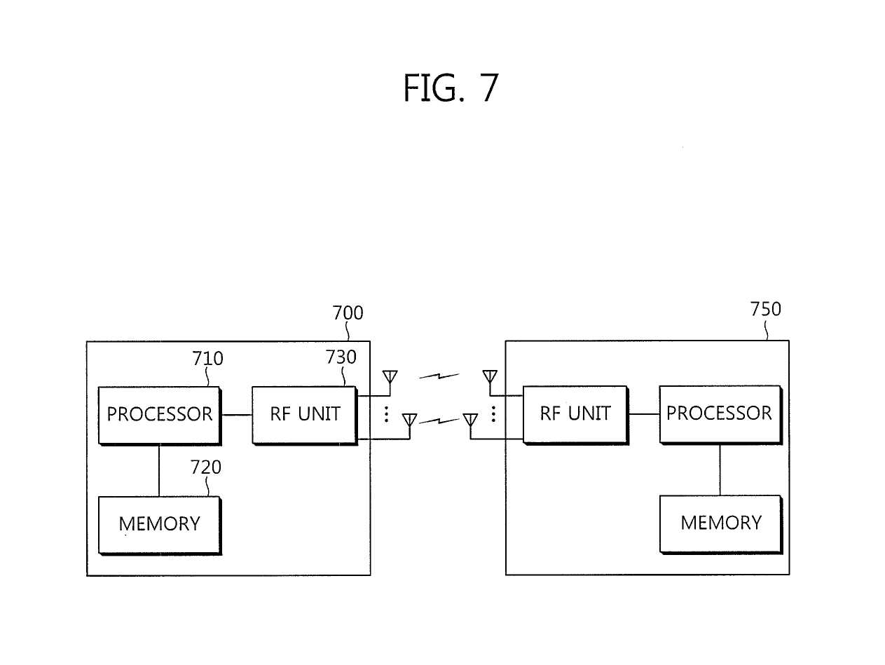

FIG. 7 is a block diagram of a wireless apparatus implementing an embodiment of the present invention.

The wireless apparatus 700 includes a processor 710, a memory 720, and an RF unit 730. The RF unit 730 is functionally connected to a multi-antenna and is set to be able to transmit and/or receive data through the multi-antenna according to the method for transmitting data according to the present invention described above. The processor 710 is functionally connected to the RF unit 730 and is set to be able to implement the method suggested in the present invention. The processor 710 and/or the RF unit 730 may include an application-specific integrated circuit (ASIC), other chipsets, logical circuits, and/or data processing apparatuses. The memory 720 may include a read-only memory (ROM), a random access memory (RAM), a flash memory, a memory card, a storage medium, and/or other storage apparatus. When the embodiment is implemented by software, the above-mentioned method may be implemented by a module (process, function, or the like) that performs the above-mentioned function. The module may be stored in the memory 720 and be performed by the processor 710. The memory 720 may be in or out of the processor 710 and be connected to the processor 710 by widely known various units. The wireless apparatus 700 may be operated as a wireless communication terminal supporting various standards according to wireless communication protocols and settings implemented in the processor 710. A wireless apparatus 750 may have the same structure as that of the wireless apparatus 700, and each of the wireless apparatuses 700 and 750 may serve as terminals of a transmitting end and a receiving end. The transmitting end and the receiving end may be relatively distinguished from each other. That is, roles and functions of the transmitting end and the receiving end may be relatively determined according to a direction in which data is transmitted.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belonging to the following claims.

1. A method for selecting an antenna performed by a receiving end in a multi-antenna system, the method comprising:
configuring subcarrier groups by grouping subcarriers;
acquiring channel information between a receiving end antenna and each of a plurality of transmitting end antennas;
determining the subcarrier groups to be transmitted to each of the plurality of transmitting end antennas based on the channel information; and
transmitting antenna selection information including a result of the antenna selection to a transmitting end.

2. The method of claim 1, wherein the step of configuring subcarrier group includes setting subcarriers subjected to a similar channel environment as one group.

3. The method of claim 1, wherein the step of determining the subcarrier groups includes determining the antenna selection information by comparing the channel information and a representative value of channel characteristics of the subcarrier group with each other.

4. The method of claim 3, wherein the representative value of the channel characteristics of the subcarrier group is obtained based on at least one of sum, average, maximum value, and minimum value of channel characteristics of each of subcarriers configuring the subcarrier group.

5. The method of claim 1, wherein the antenna selection information is an index of the transmitting end antennas corresponding to the subcarrier group.

6. A method for selecting an antenna performed by a transmitting end in a multi-antenna system, the method comprising:
receiving antenna selection information from a receiving end; and
allocating subcarriers to each of a plurality of transmitting end antennas based on the antenna selection information,
wherein the antenna selection information is determined based on channel information between a receiving end antenna and each of the plurality of transmitting end antennas.

7. The method of claim 6, wherein the step of allocating subcarriers includes allocating the subcarriers to each of the plurality of transmitting end antennas in a group unit by setting each of subcarriers subjected to a similar channel environment as one subcarrier group.

8. The method of claim 7, wherein the antenna selection information is determined by comparing the channel information and a representative value of channel characteristics of the subcarrier group with each other.

9. The method of claim 8, wherein the representative value of the channel characteristics of the subcarrier group is obtained based on at least one of the sum, the average, the maximum value, and the minimum value of channel characteristics of each of subcarriers configuring the subcarrier group.

10. The method of claim 7, the antenna selection information is an index of the transmitting end antennas corresponding to the subcarrier group.
